(19) United States
(12) Patent Application Publication
(10) Pub. No.: US 2004/0012278 A1
(43) Pub. Date: Jan. 22, 2004

(54) PROTECTION DEVICE OF THE DRIVE MECHANISM OF A CLOCK

(76) Inventor: Cheng-Te Wang, Taichung Hsien (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/196,455

(22) Filed: Jul. 16, 2002

(51) Int. Cl. H02K 7/10

(52) U.S. Cl. 310/75 R

(57) ABSTRACT

A protection device of a drive mechanism of a clock is provided. The drive mechanism includes a driven member, and a driving member for driving the driven member. The protection device is mounted between the driving member and the driven member, and includes a first magnetic member mounted in the driven member, and a second magnetic member mounted in the driving member and attracted with the first magnetic member by a magnetic force, so that the driven member may be rotated by rotation of the driving member. Thus, when a resistance exerted on the driven member is greater than the magnetic force between the first magnetic member and the second magnetic member, the driving member idles, so as to protect the direct current small motor.

### BACKGROUND OF THE INVENTION

1. Field of the Invention

The present invention relates to a protection device of a drive mechanism of a clock, and more particularly to a protection device of a drive mechanism of a clock for protecting the direct current small motor to prevent the direct current small motor from being worn or burned.

2. Description of the Related Art

A conventional clock comprises a drive mechanism which includes a direct current small motor, a worm wheel, a gear, a swing arm, and an ornament. The worm wheel is rotated by the direct current small motor to rotate the gear which drives and rotates the swing arm which is pivoted to move the ornament reciprocally. The direct current small motor has a fixed operation time, so that when the swing arm encounters an external resistance during the movement process, the ornament cannot be pushed outward or pulled inward to the determined position exactly. Thus, it is necessary to increase the operation time of the direct current small motor, so that the swing arm has enough time to push the ornament to the determined position.

However, when the swing arm does not encounter an external resistance and may be pivoted conveniently during the movement process, the ornament will be pushed to the determined position before the preset time, so that the gear and the worm wheel cannot be rotated successively, and the rotor of the direct current small motor will idle, thereby easily wearing or burning the direct current small motor.

SUMMARY OF THE INVENTION

The primary objective of the present invention is to provide a protection device of a drive mechanism of a clock for protecting the direct current small motor to prevent the direct current small motor from being worn or burned.

In accordance with the present invention, there is provided a protection device of a drive mechanism of a clock, the drive mechanism including a driven member, and a driving member for driving the driven member, wherein:

the protection device is mounted between the driving member and the driven member of the drive mechanism and includes:

a first magnetic member mounted in the driven member of the drive mechanism; and

a second magnetic member mounted in the driving member of the drive mechanism and attracted with the first magnetic member by a magnetic force, so that when the driving member is rotated, the driven member of the drive mechanism is rotated by rotation of the driving member of the drive mechanism;

when a resistance exerted on the driven member of the drive mechanism is greater than the magnetic force between the first magnetic member and the second magnetic member, the driving member of the drive mechanism idles, so as to protect the direct current small motor.

Preferably, the driven member of the drive mechanism is a swing arm pivotally mounted in a box. The box is provided with an upright shaft for pivotally mounting the swing arm, the swing arm is formed with a recess, an extension post is provided in the recess of the swing arm, and is formed with a shaft hole for passage of the shaft, and the first magnetic member is mounted in the recess of the swing arm and is formed with a shaft hole for insertion of the extension post of the swing arm. The extension post of the swing arm has an outer wall provided with multiple locking blocks, and the shaft hole of the first magnetic member has a wall formed with multiple locking grooves for locking the multiple locking blocks of the extension post of the swing arm, so that the first magnetic member may be secured in the recess of the swing arm rigidly and stably.

Preferably, the driving member of the drive mechanism is a gear rotatably mounted in a box. The box is provided with an upright shaft for pivotally mounting the gear, the gear is formed with a recess, an extension post is provided in the recess of the gear and is formed with a shaft hole for passage of the shaft, and the second magnetic member is mounted in the recess of the gear and is formed with a shaft hole for insertion of the extension post of the gear. The extension post of the gear has an outer wall provided with multiple locking blocks, and the shaft hole of the second magnetic member has a wall formed with multiple locking grooves for locking the multiple locking blocks of the extension post of the gear, so that the second magnetic member may be secured in the recess of the gear rigidly and stably.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a protection device of a drive mechanism of a clock in accordance with a preferred embodiment of the present invention;

FIG. 1A is a partially enlarged view of the protection device of a drive mechanism of a clock as shown in FIG. 1;

FIG. 2 is a top plan cross-sectional assembly view of the protection device of a drive mechanism of a clock as shown in FIG. 1, wherein the door of the ornament is opened;

FIG. 3 is a top plan cross-sectional assembly view of the protection device of a drive mechanism of a clock as shown in FIG. 1, wherein the ornament is expanded;

FIG. 4 is a front plan cross-sectional assembly view of the protection device of a drive mechanism of a clock as shown in FIG. 1;

FIG. 5 is a top plan cross-sectional assembly view of the protection device of a drive mechanism of a clock as shown in FIG. 1, wherein the drive mechanism is started; and

FIG. 6 is a top plan cross-sectional assembly view of the protection device of a drive mechanism of a clock as shown in FIG. 1, wherein the door of the ornament is closed and the gear idles.

### DETAILED DESCRIPTION OF THE INVENTION

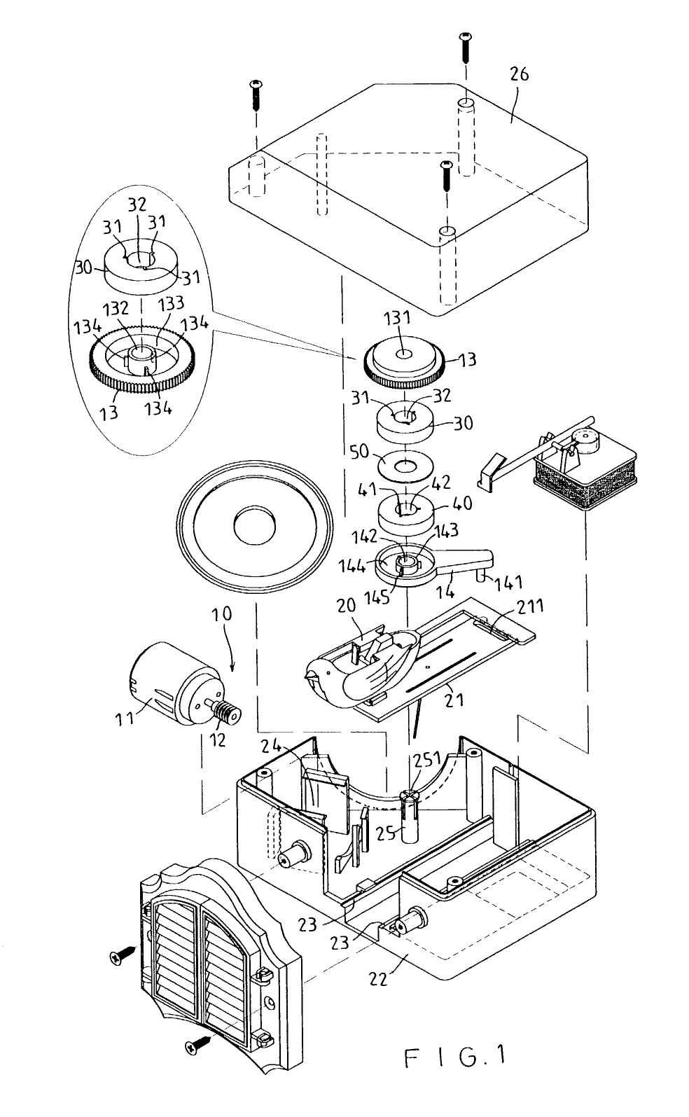

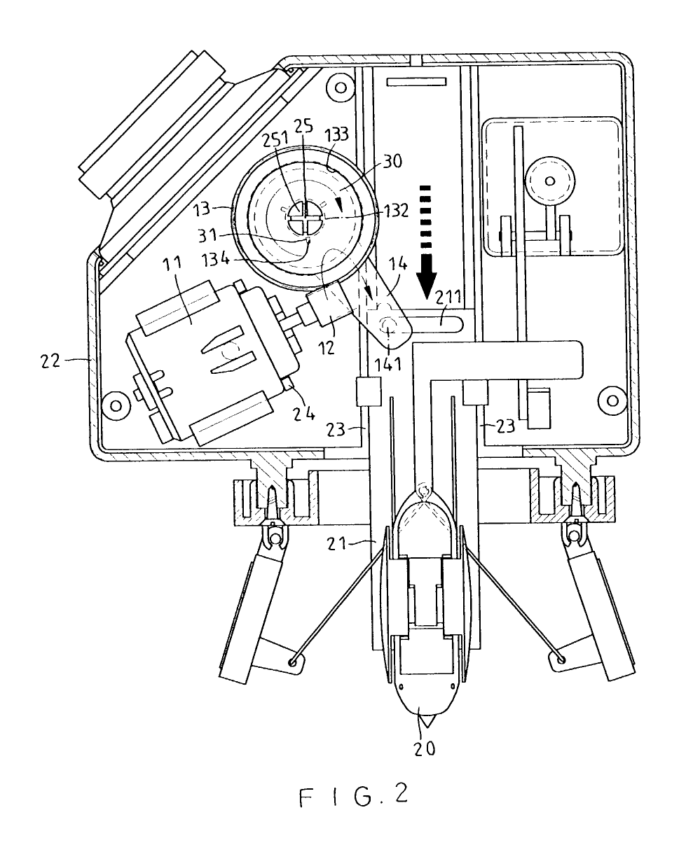

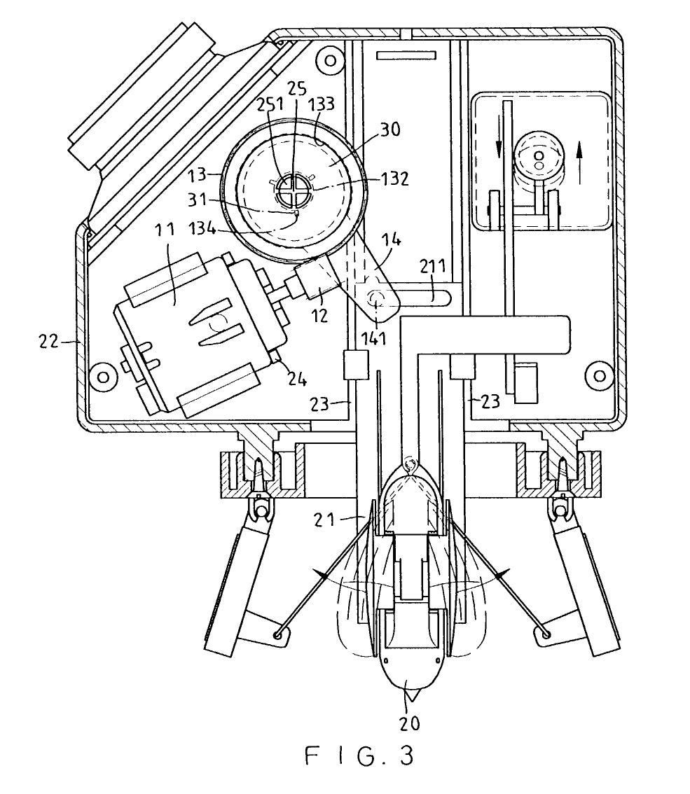

Referring to the drawings and initially to FIGS. 1-3, a protection device of a drive mechanism of a clock in accordance with a preferred embodiment of the present invention is shown. The clock comprises a drive mechanism 10 which includes a direct current small motor 11, a worm wheel 12, a gear 13, and a swing arm 14.

The clock further comprises an ornament 20 having the configuration of a bird. The ornament 20 is mounted on a first end of a bottom plate 21 which is slidably mounted in a guide track 23 of a box 22. The bottom plate 21 has a second end formed with a slide slot 211 for pivoting the swing arm 14. The swing arm 14 is pivotally mounted in the box 22, and has a distal end having a bottom provided with a slide stub 141 slidably mounted in the slide slot 211 of the bottom plate 21. Thus, when the swing arm 14 is driven by the direct current small motor 11 of the drive mechanism 10 to pivot, the slide stub 141 of the swing arm 14 may slide in the slide slot 211 of the bottom plate 21 to drive the bottom plate 21 to move reciprocally, so that the bottom plate 21 together with the ornament 20 may be pushed outward to protrude outward from the box 22, and may be pulled inward to retract into the box 22.

When the guide track 23 of the box 22 is stopped by a foreign article, or when the bottom plate 21 is not mounted on the guide track 23 of the box 22 straightly and smoothly, the bottom plate 21 together with the ornament 20 cannot be pushed outward or pulled inward to the determined position exactly. Thus, when the swing arm 14 encounters an external resistance during the movement process, it is necessary to increase the operation time of the direct current small motor 11 through about several seconds, so that the swing arm 14 has enough time to push the bottom plate 21 together with the ornament 20 to the determined position.

Under this condition, the detailed situation of the drive mechanism 10 will be described completely as follows.

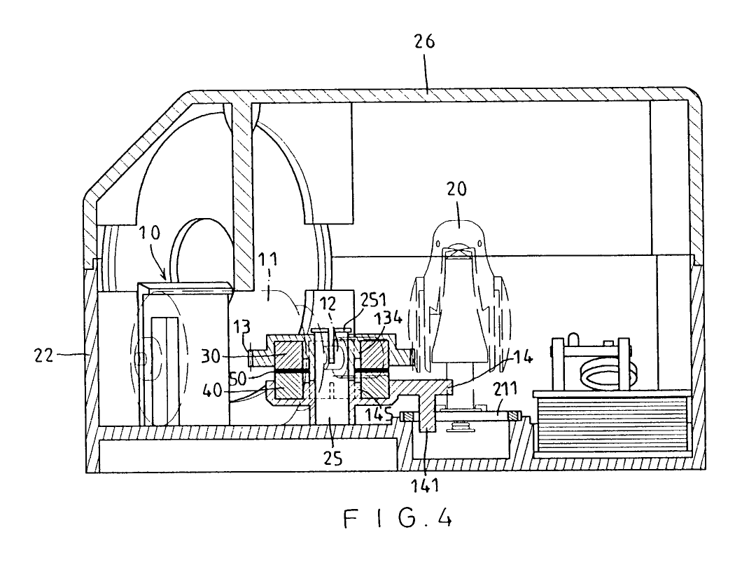

Referring to FIGS. 1, 1A and 4, the inside of the box 22 is provided with a fixing seat 24 for mounting the direct current small motor 11, and is provided with an upright shaft 25 for pivotally mounting the swing arm 14, a first magnetic member 40, a washer 50, a second magnetic member 30, and the gear 13. The gear 13 meshes with the worm wheel 12 of the direct current small motor 11. The shaft 25 has a top provided with an elastic locking hook 251 for integrally retaining the swing arm 14, the first magnetic member 40, the washer 50, the second magnetic member 30 and the gear 13 on the shaft 25. A cover 26 is mounted on the top of the box 22 for covering the box 22.

The swing arm 14 is pivotally mounted on the shaft 25, and is formed with a recess 144. An extension post 143 is provided in the recess 144 of the swing arm 14, and is formed with a shaft hole 142 for passage of the shaft 25. The extension post 143 of the swing arm 14 has an outer wall provided with multiple locking blocks 145. The first magnetic member 40 is mounted in the recess 144 of the swing arm 14, and is formed with a shaft hole 42 for insertion of the extension post 143 of the swing arm 14. The wall of the shaft hole 42 of the first magnetic member 40 is formed with multiple locking grooves 41 for locking the multiple locking blocks 145 of the extension post 143 of the swing arm 14, so that the first magnetic member 40 may be secured in the recess 144 of the swing arm 14 rigidly and stably.

The gear 13 is formed with a recess 133. An extension post 132 is provided in the recess 133 of the gear 13, and is formed with a shaft hole 131 for passage of the shaft 25. The extension post 132 of the gear 13 has an outer wall provided with multiple locking blocks 134. The second magnetic member 30 is mounted in the recess 133 of the gear 13, and is formed with a shaft hole 32 for insertion of the extension post 132 of the gear 13. The wall of the shaft hole 32 of the second magnetic member 30 is formed with multiple locking grooves 31 for locking the multiple locking blocks 134 of the extension post 132 of the gear 13, so that the second magnetic member 30 may be secured in the recess 133 of the gear 13 rigidly and stably.

Thus, the first magnetic member 40 and the second magnetic member 30 may be attracted with each other, so that the swing arm 14 may be rotated by the gear 13 which may be rotated by the worm wheel 12 of the direct current small motor 11. In addition, the washer 50 is mounted between the first magnetic member 40 and the second magnetic member 30, thereby reducing possibility of wear of the first magnetic member 40 and the second magnetic member 30.

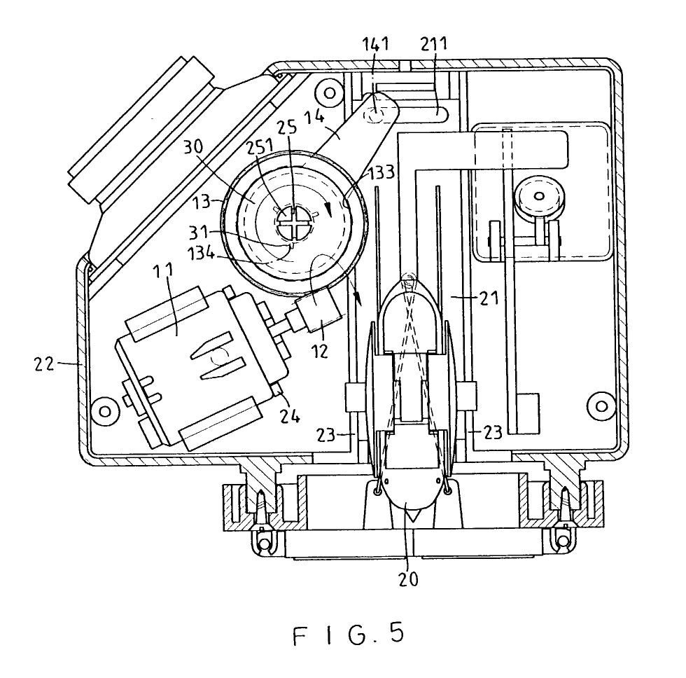

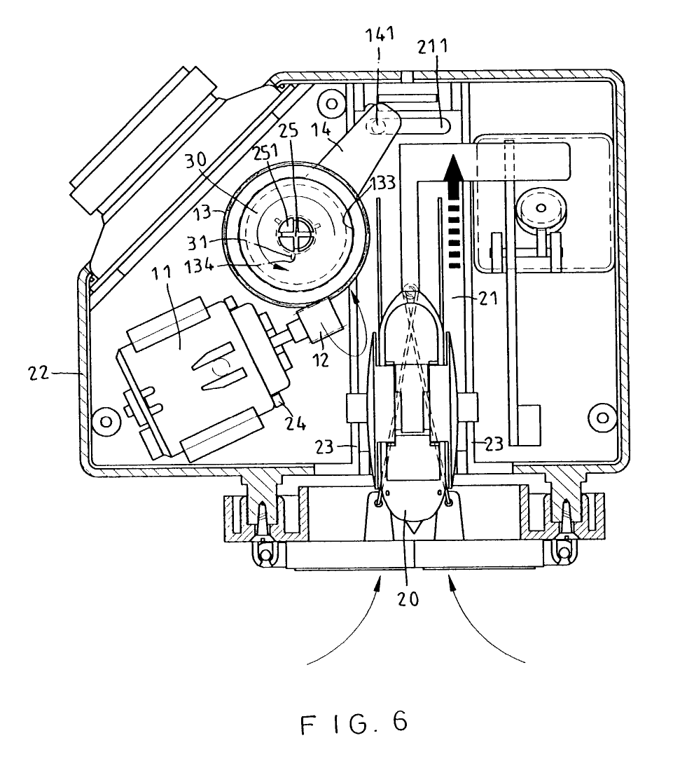

In the practical use, FIGS. 5 and 6 with reference to FIG. 1, the first magnetic member 40 and the second magnetic member 30 are normally attracted with each other, so that the swing arm 14 may be rotated in concert with the gear 13 which may be rotated by the worm wheel 12 of the direct current small motor 11. Thus, rotation of the gear 13 may drive the swing arm 14 to reciprocally pivot about the shaft 25, so that the bottom plate 21 together with the ornament 20 may be driven by the swing arm 14 to slide in the guide track 23 of the box 22.

When the bottom plate 21 encounters a resistance during the movement process, the operation time of the direct current small motor 11 has been lengthened, so that the bottom plate 21 together with the ornament 20 may be pushed outward or pulled inward to the determined position exactly.

When the bottom plate 21 does not encounter a resistance during the movement process, the bottom plate 21 together with the ornament 20 will be pushed outward or pulled inward to the determined position previously, and the gear 13 will idle, so that the operation of the direct current small motor 11 will continue until the preset time ends, thereby protecting the direct current small motor 11 without being burned out.

Accordingly, in accordance with the preferred embodiment of the present invention, the swing arm 14 may be pivoted reciprocally to push the bottom plate 21 together with the ornament 20 to a determined position for display.

When the swing arm 14 encounters an external resistance during the movement process, it is necessary to increase the operation time of the direct current small motor 11, so that the swing arm 14 has enough time to push the bottom plate 21 together with the ornament 20 to the determined position. Alternatively, when the swing arm 14 does not encounter an external resistance and may be pivoted conveniently during the movement process, the bottom plate 21 together with the ornament 20 will be pushed to the determined position before the preset time, so that the gear 13 and the worm wheel 12 cannot be rotated successively, and the rotor of the direct current small motor 11 will idle, thereby easily wearing or burning the direct current small motor 11.

Thus, the mutually attracted first magnetic member 40 and second magnetic member 30 are mounted between the swing arm 14 and the gear 13. In such a manner, the first magnetic member 40 and the second magnetic member 30 may be integrally combined with each other during the normal operation, so that the swing arm 14 may be rotated by the gear 13. When the bottom plate 21 together with the ornament 20 is pushed by the swing arm 14 to the determined position before the preset time and the direct current small motor 11 continues to operate, the resistance exerted on the pivot arm 14 of the drive mechanism 10 is greater than the magnetic force between the first magnetic member 40 and the second magnetic member 30, so that the gear 13 of the drive mechanism 19 idles. Thus, the direct current small motor 11 continues to operate without exceeding the load until the preset time ends, so that the direct current small motor 11 will not be worn or burned, so as to protect the direct current small motor 11. In addition, the washer 50 is mounted between the first magnetic member 40 and the second magnetic member 30, thereby reducing possibility of wear of the first magnetic member 40 and the second magnetic member 30.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A protection device of a drive mechanism of a clock, the drive mechanism including a driven member, and a driving member for driving the driven member, wherein:
the protection device is mounted between the driving member and the driven member of the drive mechanism and includes:
a first magnetic member mounted in the driven member of the drive mechanism; and
a second magnetic member mounted in the driving member of the drive mechanism and attracted with the first magnetic member by a magnetic force, so that when the driving member is rotated, the driven member of the drive mechanism is rotated by rotation of the driving member of the drive mechanism;
when a resistance exerted on the driven member of the drive mechanism is greater than the magnetic force between the first magnetic member and the second magnetic member, the driving member of the drive mechanism idles.

2. The protection device of a drive mechanism of a clock in accordance with claim 1, wherein the driven member of the drive mechanism is a swing arm pivotally mounted in a box.

3. The protection device of a drive mechanism of a clock in accordance with claim 2, wherein the box is provided with an upright shaft for pivotally mounting the swing arm, the swing arm is formed with a recess, an extension post is provided in the recess of the swing arm, and is formed with a shaft hole for passage of the shaft, and the first magnetic member is mounted in the recess of the swing arm and is formed with a shaft hole for insertion of the extension post of the swing arm.

4. The protection device of a drive mechanism of a clock in accordance with claim 3, wherein the extension post of the swing arm has an outer wall provided with multiple locking blocks, and the shaft hole of the first magnetic member has a wall formed with multiple locking grooves for locking the multiple locking blocks of the extension post of the swing arm, so that the first magnetic member may be secured in the recess of the swing arm rigidly and stably.

5. The protection device of a drive mechanism of a clock in accordance with claim 3, wherein the shaft has a top provided with an elastic locking hook for integrally retaining the swing arm on the shaft.

6. The protection device of a drive mechanism of a clock in accordance with claim 1, wherein the driving member of the drive mechanism is a gear rotatably mounted in a box

7. The protection device of a drive mechanism of a clock in accordance with claim 6, wherein the box is provided with an upright shaft for pivotally mounting the gear, the gear is formed with a recess, an extension post is provided in the recess of the gear and is formed with a shaft hole for passage of the shaft, and the second magnetic member is mounted in the recess of the gear and is formed with a shaft hole for insertion of the extension post of the gear.

8. The protection device of a drive mechanism of a clock in accordance with claim 7, wherein the extension post of the gear has an outer wall provided with multiple locking blocks, and the shaft hole of the second magnetic member has a wall formed with multiple locking grooves for locking the multiple locking blocks of the extension post of the gear, so that the second magnetic member may be secured in the recess of the gear rigidly and stably.

9. The protection device of a drive mechanism of a clock in accordance with claim 7, wherein the shaft has a top provided with an elastic locking hook for integrally retaining the gear on the shaft.

10. The protection device of a drive mechanism of a clock in accordance with claim 1, further comprising a washer mounted between the first magnetic member and the second magnetic member.

11. The protection device of a drive mechanism of a clock in accordance with claim 1, wherein the drive mechanism further includes a direct current small motor, and a worm wheel mounted on the direct current small motor for rotating the driving member.
